(19) United States
(12) Patent Application Publication
(10) Pub. No.: US 2013/0268594 A1
(43) Pub. Date: Oct. 10, 2013

(54) SYSTEM AND METHOD FOR PROVIDING LOCATION AND TIME FRAME RELATED SOCIAL NETWORK SERVICES

(71) Applicant: Krzysztof Adam Kogut, Warsaw (PL)

(72) Inventor: Krzysztof Adam Kogut, Warsaw (PL)

(21) Appl. No.: 13/575,081

(22) PCT Filed: Nov. 23, 2010
(86) PCT No.: PCT/EP2010/068040

§ 371 Date: Jul. 25, 2012

(51) Int. Cl. G06F 15/173

(52) U.S. Cl. CPC G06F 15/17306
USPC 709/204

(57) ABSTRACT

A system and method for providing social network services on the basis of users locations and the related time frame. The aforesaid system and method store within users profiles personal information comprising location, the related time frame, and the visibility zone or visibility place defined by the users. When a user inputs one or more locations and the related time frame into the system, the system in return provides the user with information about other users assigned to the same or a nearby location and the same or similar time frame. However, the system displays only those other users who included the previously mentioned user's location within their visibility zone or visibility place settings. The users can interact with visible users by sharing information, including, but not limited to, messages, pictures, music, movies, books and news.

### BRIEF DESCRIPTION OF THE DRAWINGS

FIG. 1 illustrates a flow diagram of an exemplary process of collecting users' location, the related time frame assigned to the location and the visibility zone or visibility place.

FIG. 2 is a schematic block diagram illustrating the environment and embodiment of social networking system.

FIG. 3 illustrates an exemplary act of associating the location with the related time frame assigned to the location.

FIG. 4 illustrates an exemplary act of presenting profile information of one or more users to another user on the basis of the location, the related time frame and the visibility zone or visibility place.

FIG. 5 illustrates an exemplary visibility zone and visibility place of one or more users to another user on the basis of the location and the related time frame.

### DETAILED DESCRIPTION

A detailed description of the invention embodiments is provided below, along with figures illustrating its characteristics. The scope of the invention is limited only by the claims. It is not limited to any embodiments provided for the purpose of example.

The invention includes a system and method for social networking. Data concerning one or more locations, the related time frame assigned to each location and the allowed visibility zone or visibility place (collectively referred to as “Location-Time-Distance”) are received from the social network members. The social network members are visible to other social network members who are assigned to the location and the related time frame, only if such location is placed within the allowed visibility zone or visibility place specified by the social network members. What follows, the visible social network members can interact with each other. The visible social network members are assigned to the Location-Time-Distance groups.

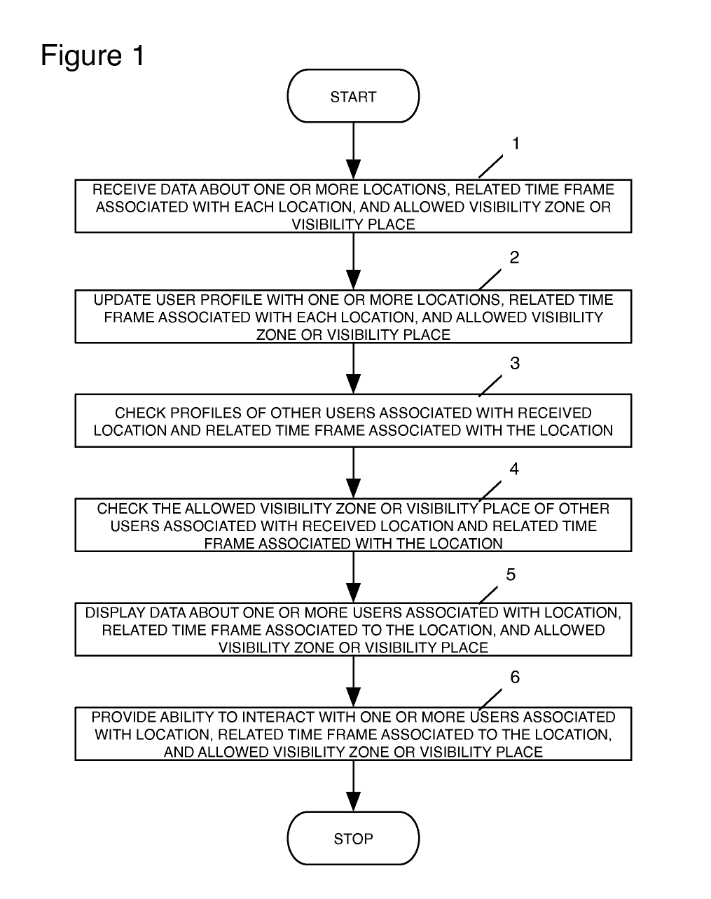

FIG. 1 illustrates a flow diagram of an exemplary process of collecting users' location, the related time frame assigned to the location and visibility zone or visibility place.

At step (1), the information concerning one or more locations, the related time frame associated with each location, and the allowed visibility zone or visibility place is received. For example, User provides a list of locations, dates and time where and when the User was, is, or will be and the allowed visibility zone or visibility place where those locations are situated.

At step (2), the information on one or more locations, the related time frame associated with each location, and the allowed visibility zone or visibility place is saved within the User's profile.

At step (3), the information concerning other Users whose profiles include the same or a nearby location and the same or similar related time frame assigned to the location is retrieved.

At step (4), the information on the allowed visibility zone or visibility place is retrieved from the profiles of other Users who share in their profile the same or a nearby location and the same or similar related time frame assigned to the location.

At step (5), the information about other Users is displayed only if the other Users share in their profile the same or a nearby location, the same or similar related time frame assigned to the location, and the User's location is placed within the allowed visibility zone or visibility place as specified by other Users whose data are about to be displayed.

At step (6), the ability to interact with other Users is provided only if the other Users share within their profile the same or a nearby location, the same or similar related time frame assigned to the location, and the User's location is placed within the allowed visibility zone or visibility place as specified by other Users whose data are about to be displayed.

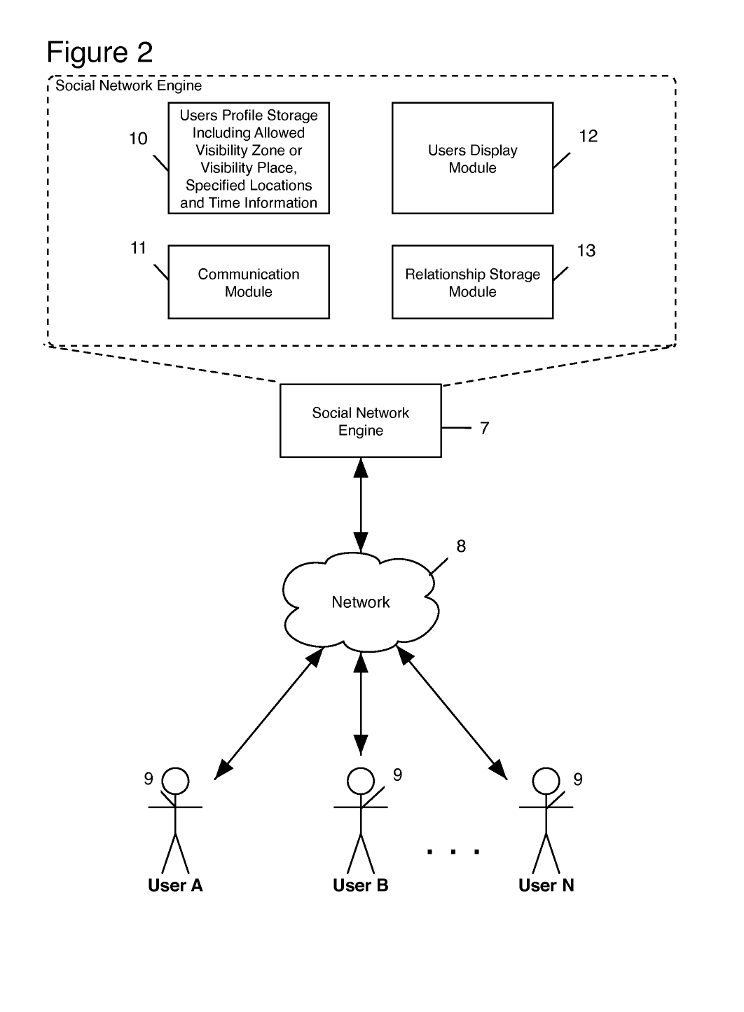

FIG. 2 is a schematic block diagram illustrating the environment and embodiment of social networking system.

One or more Users (9) are in communication via Network (8) with a Social Network Engine (7). The Social Network Engine (7) may comprise a social networking website, one or more servers operating the social networking website or any other device or application capable of providing social networking services via the Network (8). The Users (9) can access the services provided by the Social Network Engine (7) via the Network (8). Optionally, one or more Users (9) may be able to access the Social Network Engine (7) directly. The Users (9) can access the Social Network Engine (7) via a computing device, such as a laptop or a desktop computer, a cellular telephone, a personal digital assistant (PDA), a set top box, and so forth. The Users (9) are typically members of a social networking website associated with the Social Network Engine (7), for example, and thus comprise the social network members.

According to the exemplary embodiments, a User (9), such as User A, User B and User N, maintains a social networking personal profile comprising information on one or more locations, the related time frame associated with each location, and the allowed visibility zone or visibility place. Users (9) sharing in their profile the same or a nearby location and the same related time frame assigned to the location can see each other profiles only if the other Users (9) have User's location placed within the allowed visibility zone or visibility place specified by other Users (9) whose data are about to be displayed. The visible Users can interact with each other via the Network Social Engine (7), including, but not limited to, exchanging messages, photos, music, and news.

The Network Social Engine (7) comprises a storage for personal networking profiles (10), user display module (12), communication module (11) and relationship storage module (13). Personal networking profiles storage (10) stores information concerning the social networking personal profile which includes data on one or more locations, the related time frame associated with each location, and the allowed visibility zone or visibility place. Display module (12) displays information about Users sharing in their profile the same or a nearby location and the same related time frame assigned to the location placed within the allowed visibility zone or visibility place as specified by other Users whose data . are about to be displayed. Communication module (11) allows the Users to interact (9) via the Network Social Engine (7), including, but not limited to, exchanging messages, photos, music and news. Relationship storage module (13) stores information about relations between Users (9) comprising the Users' affiliation to (9) in Location-Time-Distance groups.

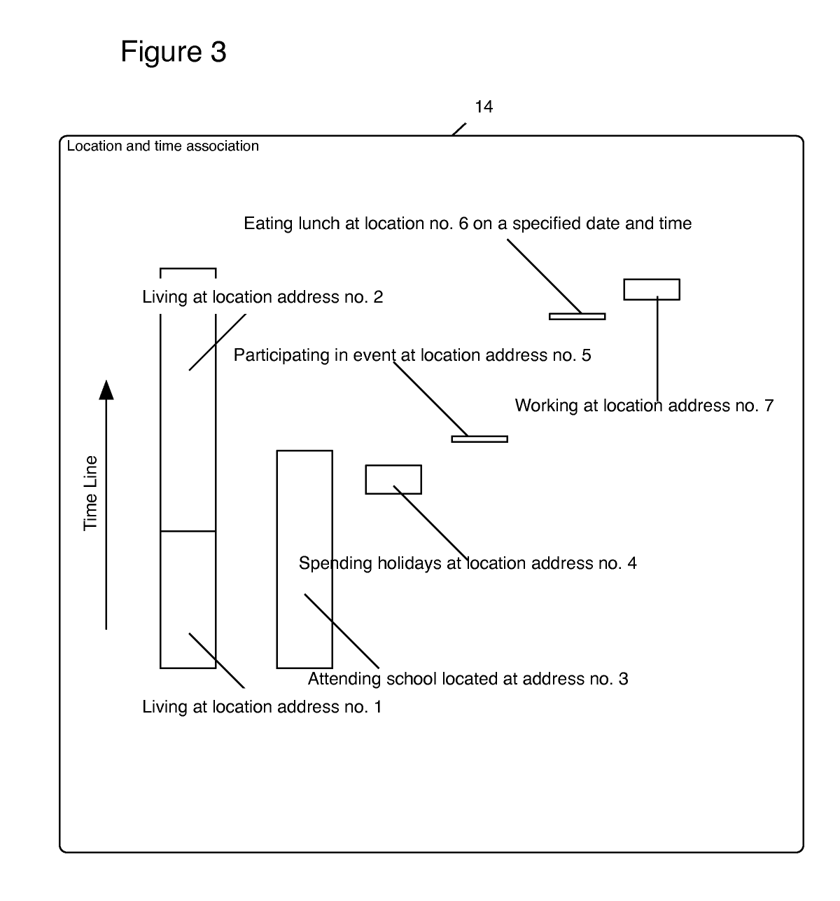

FIG. 3 illustrates an exemplary act of associating the location and the related time frame assigned to the location.

Each location is strictly related to the time when the location plays significant role in social networking, including, but not limited to, place of residence in particular period of time, place of studying in particular period of time, holidays spent at a particular point in time, participating in an event on a specified date, a meal in a restaurant on a particular day or work in a specific place at a particular point in time.

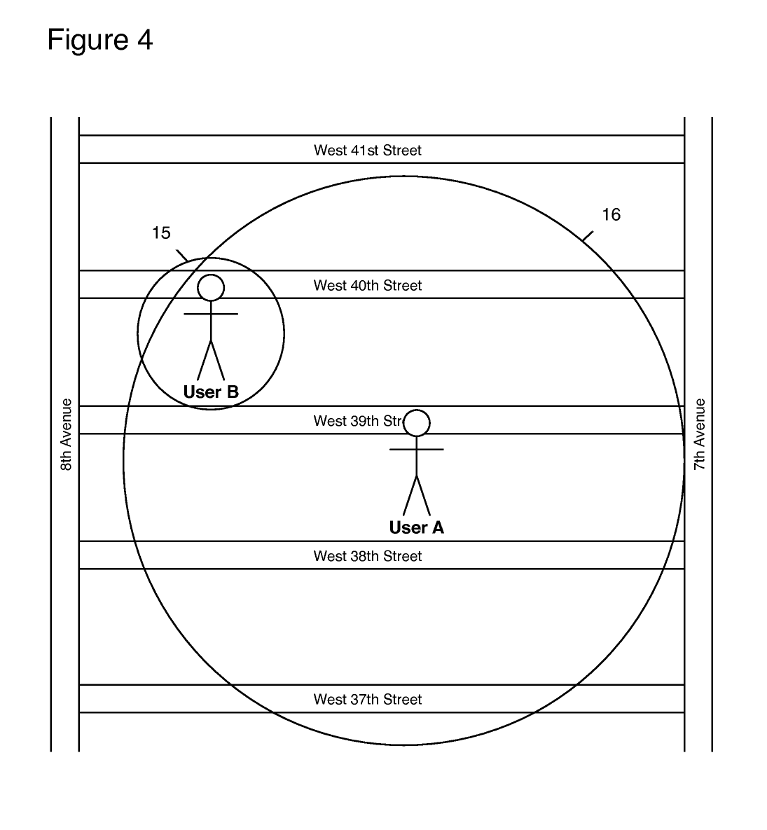

FIG. 4 illustrates an exemplary act of presenting profile information of one or more users to another user on the basis of the location, the related time frame and the visibility zone or visibility place.

In a particular place, with an actual reference to the reality, and in a define period of time or date saved within Users' profiles, the profiles of both Users may be visible to each other and the Users can interact with each other only if the User's location is placed within the allowed visibility zone or visibility place specified by other Users whose data are about to be displayed. In this example User B can see User A profile information because User B is situated within the allowed visibility zone (16) of User A.

However, User A cannot see User B profile information because User A is situated outside the allowed visibility zone (15) of User B.

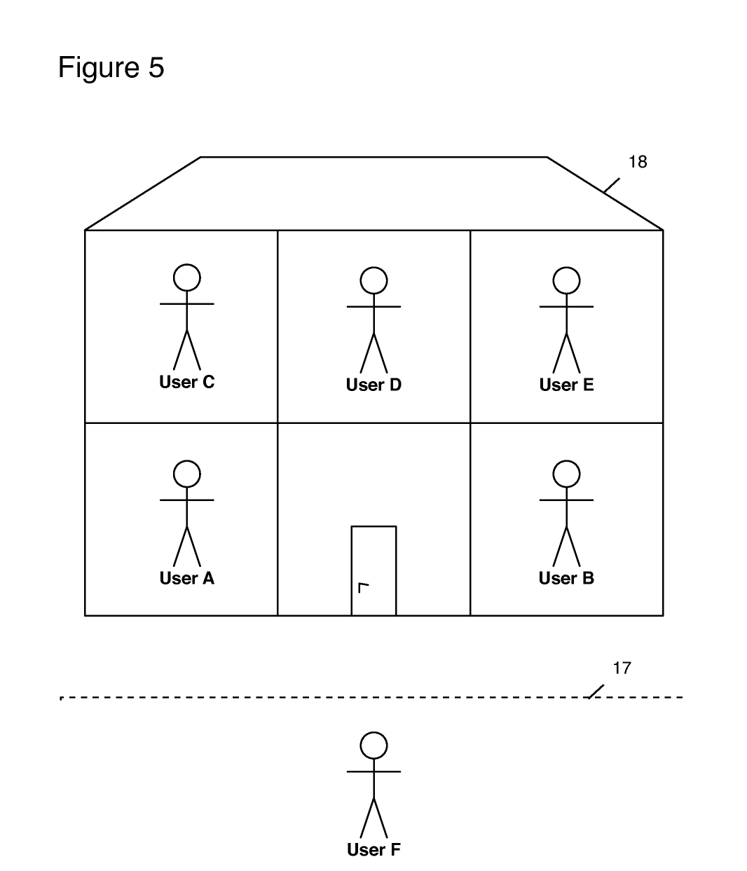

FIG. 5 illustrates an exemplary visibility zone and visibility place of one or more users to another user on the basis of the location and the related time frame.

Reducing the possibilities to watch other Users' profiles may be conducted throughout settling visibility zone (17) or establishing visibility place (18) where Users can mutually observe other Users' profiles. In the example Users A-E see their profiles both ways, whereas User F does not see the profiles of Users A-E due to the fact that their allowed visibility zone (17) or visibility place (18) does not encompass the position of User F.

What is claimed is:

1. A method for an online social network comprising:
a. maintaining profiles for users of a social networking system, wherein the system maintains one or more locations where one or more users were, are, or will be present at a specific time or for a specified period of time;
b. associating a user of the social networking system with aforesaid one or more locations and the related time frame assigned to the one or more locations;
c. providing users with the information about one or more users of a social networking system only if the other users of the social networking system are associated with the same or a nearby location, the same or similar time frame assigned to the location, and the user's location is placed within the visibility zone or visibility place specified by other users whose data are about to be displayed;
d. providing users with the ability of interacting with one or more users of a social networking system, which comprises exchanging data between the users, only if the other users of the social networking system are associated with the same or a nearby location, the same or similar time frame assigned to the location, and the user's location is placed within the visibility zone or visibility place specified by other users.

2. The method according to claim 1, wherein the interacting users interact within groups comprising an online group of users within the social networking system.

3. The method according to claim 2, wherein the groups of users exist outside of the social networking system.

4. The method according to claim 1, wherein the locations exist outside of the social networking system.

5. The method according to claim 1, wherein the data is exchanged between the users in one or more forms comprising: messages; pictures; music; books; and movies.

6. The method according to claim 1, wherein the amount of the information exchanged between the users depends on the distance between the locations specified by the users.

7. The method according to claim 6, wherein the content of the information exchanged between the users depends on the distance between the locations specified by the users.

8. The method according to claims 6 and 7, wherein the amount and content of information exchanged between the users depend on the type of location associated with the users comprising: school, college, university, business, non-profit entity, place of event, building, street, vehicle, neighborhood, city, and position described by an absolute location.

9. A system for an online social network comprising:
a. database configured to store data about one or more locations, the related time frame assigned to the one or more locations, and visibility zone or visibility place specified by users;
b. display module configured to provide users with the information about one or more users of a social networking system if the other users of the social networking system are associated with the same or a nearby location, with the same or similar time frame assigned to the location, and the user's location is placed within the visibility zone or visibility place specified by other users whose data are about to be displayed;
c. communication module configured to provide the users with the ability of interacting with one or more users of a social networking system, which comprises exchanging data between the users, only if the other users of the social networking system are associated with the same or a nearby location, the same or similar time frame assigned to the location, and the user's location is placed within the visibility zone or visibility place specified by other users;
d. relationship storage module configured to maintain information about relations between users comprising the information about affiliation to the group of users.

10. The system according to claim 9, wherein the interacting users interact within groups comprising an online group of users within the social networking system.

11. The system according to claim 10, wherein the groups of users exist outside of the social networking system.

12. The system according to claim 9, wherein the locations exist outside of the social networking system.

13. The system according to claim 9, wherein the data is exchanged between the users in one or more forms comprising: messages; pictures; music; books; and movies.

14. The system according to claim 9, wherein the amount of the information exchanged between the users depends on the distance between the locations specified by the users.

15. The system according to claim 14, wherein the content of the information exchanged between the users depends on the distance between the locations specified by the users.

16. The system according to claims 14 and 15, wherein the amount and content of information exchanged between the users depend on the type of location associated with the users comprising: school, college, university, business, non-profit entity, place of event, building, street, vehicle, neighborhood, city, and position described by an absolute location.
